(19) United States
(12) Patent Application Publication
(10) Pub. No.: US 2012/0173686 A1
(43) Pub. Date: Jul. 5, 2012

(54) MOBILITY AWARE CLOUD PROVISIONING

(75) Inventors: Ronald P. Doyle, (US); David L. Kaminsky, (US)

(73) Assignee: International Business Machines Corporation, Armonk, NY (US)

(21) Appl. No.: 12/982,649

(22) Filed: Dec. 30, 2010

(51) Int. Cl. G06F 15/173

(52) U.S. Cl. 709/223

(57) ABSTRACT

Embodiments of the present invention provide a method, data processing system and computer program product for mobility aware cloud provisioning. In an embodiment of the invention, a method for mobility aware provisioning of access to a service instance executing in a host in a cloud computing can include receiving a request from a mobile computing device for access to a service in a cloud computing environment. Thereafter, an expected path of travel for the mobile computing device can be computed and a particular instance of the service executing in memory of a host in the cloud computing environment can be selected for its proximity to the expected path of travel. Finally, the particular instance of the service can be provisioned for access by the mobile computing device.

### BACKGROUND OF THE INVENTION

1. Field of the Invention

The present invention relates to cloud computing and more particularly to resource provisioning in a cloud computing environment.

2. Description of the Related Art

Cloud computing is a model of service delivery for enabling convenient, on-demand network access to a shared pool of configurable computing resources including computer communications networks, network bandwidth, servers, processing, memory, storage, applications, virtual machines, and services, that can be rapidly provisioned and released with minimal management effort or interaction with a provider of the service. This cloud model may include at least five characteristics, at least three service models, and at least four deployment models. Characteristics of cloud computing include on-demand self-service, broad network access, resource pooling, rapid elasticity, and measured service.

Cloud computing enables several different service models such as the Software as a Service (SaaS) model, the Platform as a Service (PaaS) model, and the Infrastructure as a Service (IaaS) model. Cloud computing itself can be deployed according to a number of deployment models including the private cloud model in which the cloud infrastructure is operated solely for an organization, the community cloud model in which the cloud infrastructure is shared by several organizations and supports a specific community that has shared concerns, the public cloud model in which the cloud infrastructure is made available to the general public or a large industry group and is owned by an organization selling cloud services, and the hybrid cloud model in which the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure of a network of interconnected nodes. In this regard, a typical cloud computing environment includes one or more cloud computing nodes with which local computing devices used by cloud consumers may communicate. The nodes communicate with one another and can be grouped together physically or virtually, in one or more networks, such as private, community, public, or hybrid clouds as described hereinabove, or a combination thereof. As such, the cloud computing environment can offer infrastructure, platforms and software as services for which a cloud consumer does not need to maintain resources on a local computing device. As technology evolves, the infrastructure, platforms and software as services is expected to evolve as well.

Location based services have often been used to provide enhanced service or value to mobile or transient computer users. In this regard, a location-based service first locates the computing user at a particular geographical location or region and then tailors services according to the geographic location. While the known architecture of the cloud computing environment considers the placement of client devices with respect to the server, the known architecture of the cloud computing environment fails to account for the mobility of a computing device during a computing session in the cloud.

### BRIEF SUMMARY OF THE INVENTION

Embodiments of the present invention address deficiencies of the art in respect to resource provisioning in a cloud computing environment and provide a novel and non-obvious method, system and computer program product for mobility aware cloud provisioning. In an embodiment of the invention, a method for mobility aware provisioning of access to a service instance executing in a host in a cloud computing can include receiving a request from a mobile computing device for access to a service in a cloud computing environment. Thereafter, an expected path of travel for the mobile computing device can be computed and a particular instance of the service executing in memory of a host in the cloud computing environment can be selected for its proximity to the expected path of travel. Finally, the particular instance of the service can be provisioned for access by the mobile computing device.

In one aspect of the embodiment, the expected path of travel can be computed for the mobile computing device by matching a current location of the mobile computing device to a location along a previous path of travel for the mobile computing device or, optionally another mobile computing sharing at least one characteristic with the mobile computing device. In another aspect of the embodiment, the expected path of travel can be computed for the mobile computing device by matching a current time of the request from the mobile computing device to a time of a previous path of travel for the mobile computing device. In yet another aspect of the embodiment, the expected path of travel can be computed for the mobile computing device by matching the mobile computing device to a pre-computed path of travel. In even yet another aspect of the embodiment, a particular instance of the service executing in memory of a host in the cloud computing environment can be selected according to the proximity of the host to a location along the expected path of travel associated with an expected increase in intensity of network communications for the mobile computing device when utilizing the service.

In another embodiment of the invention, a cloud computing data processing system can be provided. The system can include a server with at least one processor and memory that has been configured for communicative coupling to different hosts, each supporting at least one instance of a service in a cloud computing environment. The system further can include a data store of historical paths of travel for different users coupled to the server. Finally, the system can include a mobility aware provisioning module executing in the memory of the server. The module can include program code enabled upon execution in the server to receive a request from a mobile computing device for access to the service, to compute an expected path of travel for the mobile computing device in reference to the data store, to select a particular instance of the service in a corresponding one of the hosts that is proximate to the expected path of travel, and to provision the particular instance of the service for access by the mobile computing device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for mobility aware cloud provisioning;

FIG. 2 is a schematic illustration of a cloud computing data processing system configured for mobility aware cloud provisioning; and,

FIG. 3 is a flow chart illustrating a process for mobility aware cloud provisioning.

### DETAILED DESCRIPTION OF THE INVENTION

Embodiments of the invention provide for mobility aware cloud provisioning. In accordance with an embodiment of the invention, a request to provision access to a service in a cloud computing environment can be received in the cloud computing environment. An identity of the requestor can be determined and a likely geographic route of travel can be determined. Thereafter, a server proximate to a portion of the likely geographic route of travel can be selected to provide the requested service to the requestor. Optionally, a portion of the likely geographic route of travel corresponding to an expected elevated intensity of network communications for the requested service can be determined and a server proximate to that portion of the likely geographic route of travel can be selected to provide the requested service.

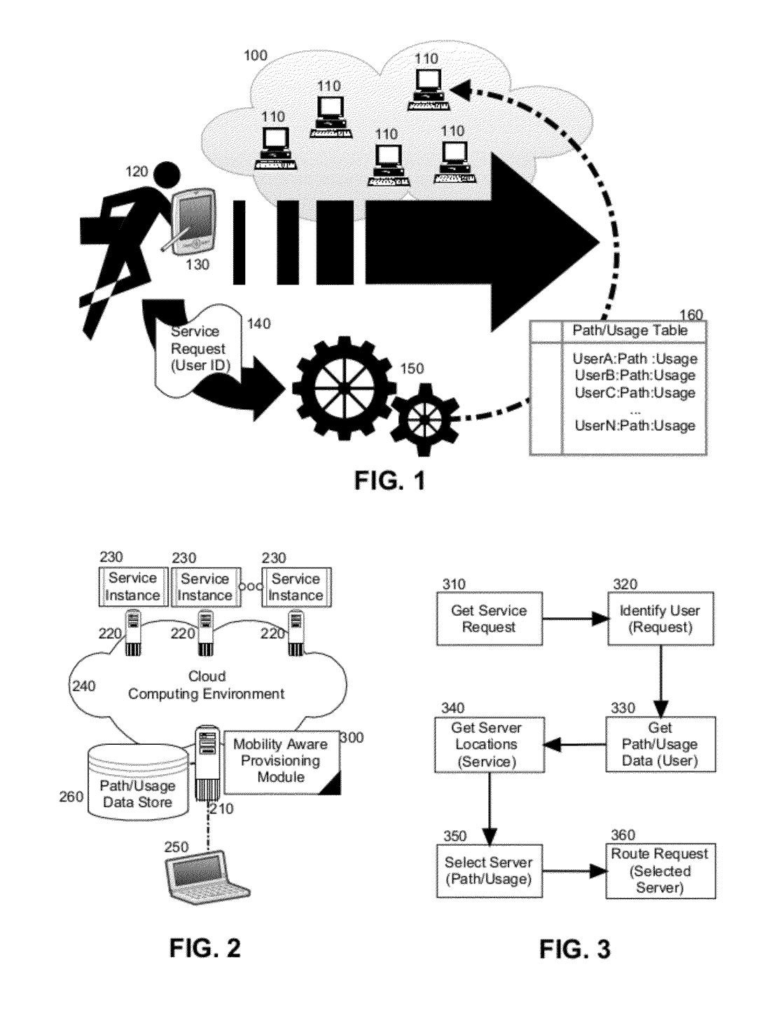

In further illustration, FIG. 1 is a pictorial illustration of a process for mobility aware cloud provisioning. As shown in FIG. 1, a computing user 120 of a service in a cloud computing environment 100 can issue from a mobile computing device 130 a request 140 for access to the service provided by different service instances executing in respective hosts 110 in the cloud computing environment 100. Mobility aware cloud provisioning logic 150 can identify the computing user 120 and determine an expected path of travel for the computing user 120 in reference to a table 160. In this regard, the table 160 can include historic geographic paths of travel for different computing users. The historic geographic paths of travel can be expressed in a number of different ways such as by a starting and finishing location or address, a sequence of way-points, or merely a sequence of one or more locations corresponding to different times of the day, days of the week, weeks of the year, etc. Optionally, the table 160 also can provide a historical indication of service usage at different times or positions along each historic geographic path of travel. As yet a further option, the table 160 can provide a historic geographical paths of other mobile computing devices that can be used to approximate or predict the expected path of travel for the computing user 120.

Using the historical data in the table 160, the mobility aware cloud provisioning logic 150 can determine an expected path of travel by correlating a current position of the mobile computing device 130 to a position in a previously traveled path of travel in the table 160. Alternatively, the expected path of travel can be determined from a time of day of the request 140 to a previously location in a previous path of travel of the user 120 at the same time of day in the past. Regardless, the mobility aware cloud provisioning logic 150 can select a particular one of the hosts 110 supporting an instance of the requested service specified by the request 140 to accommodate the end user 120 based upon the proximity of the particular one of the hosts 110 to a position along the expected path of travel. Optionally, mobility aware cloud provisioning logic 150 can select a particular one of the hosts 110 supporting an instance of the requested service specified by the request 140 to accommodate the end user 120 based upon the proximity of the particular one of the hosts 110 to an anticipated position along the expected path of travel at a time when the end user 120 is expected to experience intensified network communications according to historical usage patterns for the end user 120 evident in the table 160.

The process described in connection with FIG. 1 can be implemented in a cloud computing data processing system. In further illustration, FIG. 2 schematically shows of a cloud computing data processing system configured for mobility aware cloud provisioning. The system includes a server 210 with at least one processor and memory. The server 210 can be coupled to different hosts 220, each supporting one or more instances 230 of service logic in a cloud computing environment 240. Of note, a mobility aware provisioning module 300 can execute in the memory of the server 210 by at least one processor of the server 210.

The mobility aware provisioning module 300 can include program code enabled upon execution in the memory of the server 210 to respond to a request from a remotely disposed mobile computing device 250 for access to one of the instances 230 of the service by determining an expected path of travel for the mobile computing device 250 based upon historical path data stored in data store 260. Additionally, the program code of the mobility aware provisioning module 300 can determine a location along the expected path at which a period of intensified network communications can be expected of the mobile computing device 250 based upon past usage data evident in the data store 260. Finally, the program code of the mobility aware provisioning module 300 can select a particular one of the service instances 230 in a corresponding one of the hosts 220 most proximate to the expected path of travel for the mobile computing device 250, and optionally most proximate to a location along the expected path of travel for the mobile computing device 250 at which a period of intensified network communications can be expected of the mobile computing device 250.

In even yet further illustration of the operation of the mobility aware provisioning module 300, FIG. 3 is a flow chart illustrating a process for mobility aware cloud provisioning. Beginning in block 310, a service request can be received from a mobile computing device for access to an instance of a service provisionable in the cloud computing environment. In block 320, a user can be identified for the request and in block 330, historical path and usage data can be retrieved for the user. In block 340, different host server locations can be retrieved hosting different instances of the requested service. Thereafter, in block 350, a particular host server most proximate to an expected path of travel for the user based upon the historical path and usage data can be selected for provisioning in response to the request. Finally, in block 350 the request can be routed to the selected host server.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for mobility aware provisioning of access to a service instance executing in a host in a cloud computing environment comprising:
receiving a request from a mobile computing device for access to a service in a cloud computing environment;
computing an expected path of travel for the mobile computing device; [DLK: I'd like to also catch the case where the expected path is precomputed and the invention simply looks it up. Could we replace “computing” with “determining” and specify in the spec that “determining” could mean consulting a list of precomputed paths?
selecting a particular instance of the service executing in memory of a host in the cloud computing environment that is proximate to the expected path of travel; and,
provisioning the particular instance of the service for access by the mobile computing device.

2. The method of claim 1, wherein computing an expected path of travel for the mobile computing device, comprises matching a current location of the mobile computing device to a location along a previous path of travel for the mobile computing device.

3. The method of claim 1, wherein computing an expected path of travel for the mobile computing device, comprises matching a current time of the request from the mobile computing device to a time of a previous path of travel for the mobile computing device.

4. The method of claim 1, wherein computing an expected path of travel for the mobile computing device, comprises matching the mobile computing device to a pre-specified path of travel.

5. The method of claim 1, wherein selecting a particular instance of the service executing in memory of a host in the cloud computing environment that is proximate to the expected path of travel, comprises selecting a particular instance of the service executing in memory of a host in the cloud computing environment that is proximate to a location along the expected path of travel associated with an expected increase in intensity of network communications for the mobile computing device when utilizing the service.

6. A cloud computing data processing system comprising:
a server with at least one processor and memory and configured for communicative coupling to different hosts, each supporting at least one instance of a service in a cloud computing environment;
a data store of historical paths of travel for different users coupled to the server; and,
a mobility aware provisioning module executing in the memory of the server, the module comprising program code enabled upon execution in the server to receive a request from a mobile computing device for access to the service, to compute an expected path of travel for the mobile computing device in reference to the data store, to select a particular instance of the service in a corresponding one of the hosts that is proximate to the expected path of travel, and to provision the particular instance of the service for access by the mobile computing device.

7. The system of claim 6, wherein the program code of the module computes an expected path of travel for the mobile computing device by matching in the data store a current location of the mobile computing device to a location along a previous path of travel for the mobile computing device.

8. The system of claim 6, wherein the program code of the module computes an expected path of travel for the mobile computing device by matching in the data store a current time of the request from the mobile computing device to a time of a previous path of travel for the mobile computing device.

9. The system of claim 6, wherein the program code of the module computes an expected path of travel for the mobile computing device by matching the mobile computing device to a pre-computed path of travel.

10. The system of claim 6, wherein the program code of the module selects a particular instance of the service in a corresponding one of the hosts that is proximate to a location along the expected path of travel associated with an expected increase in intensity of network communications for the mobile computing device when utilizing the service.

11. A computer program product for mobility aware provisioning of access to a service instance executing in a host in a cloud computing environment, the computer program product comprising:
a computer readable storage medium having computer readable program code embodied therewith, the computer readable program code comprising:
computer readable program code for receiving a request from a mobile computing device for access to a service in a cloud computing environment;
computer readable program code for computing an expected path of travel for the mobile computing device;
computer readable program code for selecting a particular instance of the service executing in memory of a host in the cloud computing environment that is proximate to the expected path of travel; and,
computer readable program code for provisioning the particular instance of the service for access by the mobile computing device.

12. The computer program product of claim 11, wherein the computer readable program code for computing an expected path of travel for the mobile computing device, comprises computer readable program code for matching a current location of the mobile computing device to a location along a previous path of travel for the mobile computing device.

13. The computer program product of claim 11, wherein the computer readable program code for computing an expected path of travel for the mobile computing device, comprises computer readable program code for matching a current time of the request from the mobile computing device to a time of a previous path of travel for the mobile computing device.

14. The computer program product of claim 11, wherein the computer readable program code for computing an expected path of travel for the mobile computing device, comprises computer readable program code for matching the mobile computing device to a pre-specified path of travel.

15. The computer program product of claim 11, wherein the computer readable program code for selecting a particular instance of the service executing in memory of a host in the cloud computing environment that is proximate to the expected path of travel, comprises computer readable program code for selecting a particular instance of the service executing in memory of a host in the cloud computing environment that is proximate to a location along the expected path of travel associated with an expected increase in intensity of network communications for the mobile computing device when utilizing the service.
